(19) United States
(12) Patent Application Publication
(10) Pub. No.: US 2001/0005384 A1
(43) Pub. Date: Jun. 28, 2001

(54) Procedure for suppressing the crosstalk between multiplex channels

(76) Inventor: Erwin Kessler, Saulgau (DE)

Correspondence Address: FASSE PATENT ATTORNEYS, P.A., P.O. BOX 726, HAMPDEN, ME, 04444-0726, US

(21) Appl. No.: 09/736,671

(22) Filed: Dec. 13, 2000

(30) Foreign Application Priority Data
Dec. 24, 1999 (DE) 199 63 152.2

(51) Int. Cl. H04J 3/16; H04J 3/22

(52) U.S. Cl. 370/535; 370/465

(57) ABSTRACT

In an integrated circuit arrangement with a plurality of signal connections linked to the inputs of a multiplexer, overmodulation of the signal connections can lead to crosstalk between multiplex channels. The new procedure should suppress such crosstalk. In order to avoid overmodulation, the voltages at the signal connections are limited to permissible input voltage values, while each overmodulated signal connection is configured as an output and, depending upon the overmodulation, set to a high or low level. Whereby, in order to test whether a signal connection is overmodulated, the input voltage value at this signal connection is converted to a digital data value which, because of its final bit width, lies within a data range limited by an upper and lower data limit value. If the data value equals the upper or lower data limit value, this is interpreted as overmodulation of the relevant signal connection.

### DESCRIPTION

1. Background of the Invention

The present invention relates to a procedure for suppressing the crosstalk between multiplex channels of a multiplexer which is connected in a circuit arrangement on the input side with signal connections which can be configured as inputs and outputs.

A circuit arrangement is known from DE 43 21 014 A1 which reads in the input voltage values from a plurality of signal connections via a multiplexer and an analog-digital converter. In this circuit arrangement, parasitic current paths can become conductive if the drive of one of the signal connections is too high. Currents which flow through these current paths can lead to undesirable crosstalk between the multiplex channels of the multiplexer. In order to avoid such crosstalk, all signal connections are linked to a ground connection and the ground link is only disconnected during the reading in of an input voltage value and only for that particular signal connection at which the input voltage value to be read in is available.

The significant disadvantage of this procedure lies in the fact that it can impair the function of external circuit components which are linked to the signal connections. If such external circuit components contain, for example, filters, usually lowpass filters with a cutoff frequency that is less than one half of a defined scanning frequency, then, after the disconnection of the ground connection, these filters require a time to resettle which is a multiple of the scanning period.

2. Summary of the Invention

The object of the invention is to specify a procedure which, in a simple way, enables adequate suppression of the crosstalk between multiplex channels of a multiplexer and which does not impair the function of circuit components connected to the multiplexer.

This task is solved by the features in patent claim 1. Advantageous embodiments and further developments arise from the subclaims.

According to the invention, the multiplexer in a circuit arrangement is linked on the input side with signal connections of the circuit arrangement which can be configured as inputs and as outputs. In order to prevent crosstalk between the multiplex channels of the multiplexer, a check is first made as to whether one or more of the signal connections are overmodulated. Then, each signal connection identified as an overmodulated signal connection is configured as an output and set to a defined logical signal level. Through this measure, the voltages at the signal connections are limited to permissible input voltage values so that crosstalk between the multiplex channels arising from overmodulation can no longer occur. The signal connections not identified as overmodulated can thus be released for reading in the input voltage values applied at them.

The following procedural steps are preferably performed to test whether a signal connection is overmodulated. The relevant signal connection is configured as an input, the input voltage value at this signal connection is fed via the multiplexer to an analog-digital converter which converts it into a digital data value, and the digital data value is compared with an upper and/or lower data limit value. In this case, the upper data limit value is the maximum and the lower data limit value the minimum data value which can be output by the analog-digital converter. If the digital data value output by the analog-digital converter is equal to the lower or upper data limit value, it is assumed that the relevant signal connection is overmodulated by an impermissible input voltage value.

Preferably, each overmodulated signal connection configured as an output is set to a logical signal level which is dependent upon the input voltage value fed to this signal connection. If, during the test as to whether a signal connection is overmodulated, the analog-digital converter outputs a data value equal to the upper data limit value, this signal connection is set to a high level; however if the analog-digital converter outputs a data value equal to the lower data limit value, then this signal connection is set to a low level.

The procedural steps are preferably repeated cyclically. Thus cyclical tests are made as to whether a signal connection already identified as overmodulated is still overmodulated and the configuration of this signal connection as an output must therefore be maintained, or whether it is no longer overmodulated and can therefore be released for configuration as an input. Furthermore, signal connections that were not previously overmodulated but are now overmodulated are identified as overmodulated, configured as outputs and set to the defined logical signal level.

### BRIEF DESCRIPTION OF THE DRAWINGS

FIG. 1 a schematic circuit diagram of a circuit arrangement for performing the procedure according to the invention,

FIG. 2 a driver-stage of the circuit arrangement in FIG. 1.

### BRIEF DESCRIPTION OF THE PREFERRED EMBODIMENTS

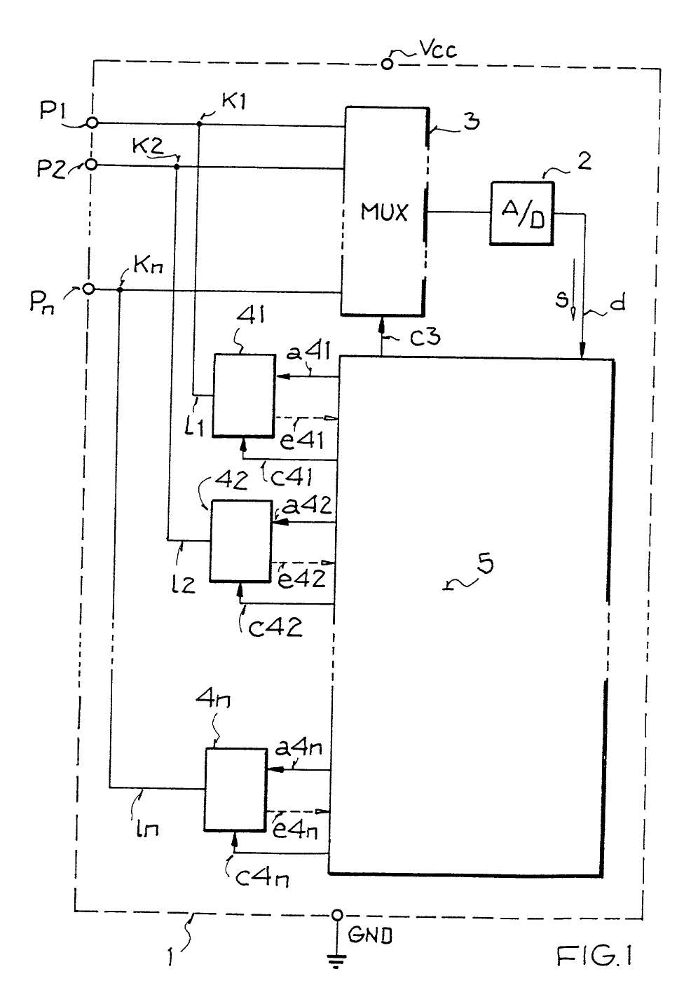

The invention is described in more detail below by means of embodiments and the figures. The circuit arrangement as shown in FIG. 1 is realized as integrated circuit 1, for example as a microprocessor or a microcontroller. With signal connections P1, P2, . . . Pn, it has a plurality of connecting pins, each of which can be configured as a digital output as well as an analog input. It is conceivable that signal connections P1, P2, . . . Pn could also be configured as digital inputs. In addition, circuit arrangement 1 includes a Vcc connection for a positive supply potential, a GND connection for a reference potential or negative supply potential, an analog-digital converter 2, a multiplexer 3, a logic component 5 and a driver stage 41, 42, . . . 4n for each of the signal connections P1, P2, . . . Pn. The signal connections P1, P2, . . . Pn are each linked with an input of the multiplexer 3, the multiplexer 3 is linked on the output side with an input of the analog-digital converter 2 and the analog-digital converter 2 is linked on the output side with the logic component 5. The logic component 5 is linked via, in each case, an output line a41, a42, . . . a4n to, in each case, one of the driver stages 41, 42, . . . 4n, and the driver stages 41, 42, . . . 4n are linked in each case via a data line l1, l2, . . . ln and in each case linked via a circuit node K1, K2, . . . Kn to, in each case, one of the circuit connections P1, P2, . . . Pn. If the signal connections P1, P2, . . . Pn can also be configured as digital inputs, the driver stages 41, 42, . . . 4n are linked via input lines e41, e42, . . . e4n to the logic component 5. The multiplexer 3 and the driver stages 41, 42,. . . 4n are driven by the logic component 5 via control lines c3, c41, c42, . . . c4n.

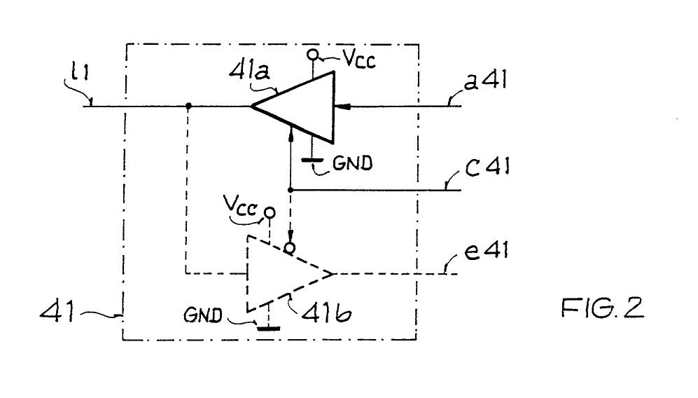

The driver stages 41, 42, . . . 4n have the same design and are described in more detail in the following by means of the first driver stage 41 shown in FIG. 2. According to FIG. 2, the driver stage 41 includes an output stage 41a, via which the output line a41 is linked to data line l1 which is connected to the circuit node K1 and the signal connection P1. The output stage 41a is designed, for example, as a tristate stage and can be activated and deactivated by the logic component 5 via control line c41. In this case, a signal transmission from the output line a41 to the data line l1 is only possible if output stage 41a is activated. If the signal connection P1 is also to be configurable as a digital input, an input stage 41b, as indicated by the dotted lines, is provided in driver stage 41, this input stage can also be activated and deactivated by the logic component 5 and can also be realized as a tristate stage, and it only enables signal transmission from the data line l1 to the input line e41 in the activated state.

The signal connection P1 is configured as an analog input by deactivating the output stage 41a and deactivating the input stage 41b. An analog input voltage is then transferred from the signal connection P1 via the multiplexer 3 to the analog-digital converter 2 and from this fed as a digital data value s via the data line d to the logic component 5 for further processing.

If output stage 41a is activated and input stage 41b is deactivated, the signal connection P1 is configured as a digital output. Digital signals are then transmitted from the logic component 5 via the output line a41, the output stage 41a, and the data line l1 to the signal connection P1. The signal connection P1 is thereby set to a high level, while the data line l1 is low-impedance linked via the output stage 41a to the Vcc connection for the positive supply potential in response to a signal issued by the logic component 5 to the output line a41. Accordingly, the signal connection P1 is set to a low level, while the data line l1 is low-impedance linked via the output stage 41a to the GND connection for the reference potential or negative supply potential.

On the other hand, if output stage 41a is deactivated and input stage 41b activated, the signal connection P1 is configured as a digital input so that digital signals are transmitted from the signal connection P1 via the data line l1, the input stage 41b and the input line e41 to the logic component 5.

In circuit arrangement 1, commercially available protective means, not shown in the figures, can be provided to protect the circuit arrangement against overvoltages. These means are, in particular, resistors which are provided in the signal paths between the signal connections P1, P2, . . . Pn and the circuit nodes K1, K2, . . . Kn linked in each case with them and/or between the circuit nodes K1, K2, . . . Kn and the inputs of the multiplexer 3 linked in each case with them. Furthermore, diodes can also be provided as protective means which link the circuit nodes K1, K2, . . . Kn in each case to the Vcc connection for the positive supply potential and with the GND connection for the reference potential or negative supply potential. In this case, the diodes are poled in such a way that they are blocking if potentials at the circuit nodes K1, K2, . . . Kn lie within one of the permitted ranges limited by the positive supply potential and the reference potential or negative supply potential.

The analog-digital converter 2 creates a digital data value s from an analog input voltage value, the bit width of which is determined by the constructional design of the analog-digital converter 2. The quantity of possible digital data values is therefore limited by an upper and lower data limit value. For example, with an 8 bit wide data value s, the lower data limit value is equal to the hexadecimal value 00 and the upper data limit value is equal to the hexadecimal value FF.

In order to avoid crosstalk between the multiplex channels of the multiplexer 3, those signal connections P1, P2, . . . Pn at which there is a risk of overmodulation are selected as the first signal connections to be tested. In the present case these are, for example, the signal connections P1 and P2. The selected signal connections P1, P2 are then tested in turn to see whether they are actually overmodulated. Whereby the following procedural steps are performed to test whether one of the signal connections P1, P2 is overmodulated. The relevant signal connection P1 or P2 is configured as an analog input, the input voltage value at this signal connection P1 or P2 is fed via the multiplexer 3 to the analog-digital converter 2 and this converts it into the digital data value s, and the digital data value s is compared in the logic component 5 with the upper and/or lower data limit values. It is sufficient to compare the digital data value s with the upper data limit value if one is simply expecting an overmodulation of the relevant signal connection P1 or P2 by an input voltage value which lies above a permissible voltage range limited by the positive supply potential and the reference potential or negative supply potential; correspondingly, it is sufficient to compare the digital data value s with the lower data limit value if one is simply expecting an overmodulation of the relevant signal connection P1 or P2 by an input voltage value which lies below the permissible voltage range.

If the digital data value s is equal to the lower or upper data limit value, the relevant signal connection P1 or P2 is identified as overmodulated by setting an overmodulation bit which has been assigned to it and marked as invalid by setting a marker bit which has been assigned to it, and thus blocked for reading in the input voltage values. The relevant signal connection P1 or P2 is furthermore configured as a digital output and, in the case of a data value s equal to the upper data limit value, it is set to a logical high level corresponding to the positive supply potential and, in the case of a data value s equal to the lower data limit value, it is set to the logical low-level corresponding to the reference potential or negative supply potential. In this way, one achieves a limitation of the voltage at the signal connections to permissible input voltage values so that crosstalk caused by impermissible input voltage values can no longer occur.

After all the signal connections identified as overmodulated have been configured as outputs and have correspondingly been set, depending upon the overmodulation, to the high or low-level, all other signal connections are released for configuration as inputs for reading in the input voltage values.

By means of cyclical repetition of the procedural steps, checks are made as to whether a signal connection identified in a previous cycle as overmodulated is still overmodulated and whether a signal connection which was not overmodulated in the previous cycle is now overmodulated. As in the previous cycles, signal connections P1, P2, . . . Pn, which are not identified as overmodulated at the current time, are released for configuration as inputs for reading in the input voltage values, and signal connections currently identified as overmodulated are configured as outputs and are set, depending upon the input voltage values, to the high or low level. In this way it is ensured that short-term overmodulation of a signal connection does not lead to permanent blocking of this connection.

What is claimed is:

1. Procedure for suppressing the crosstalk between multiplex channels of a multiplexer (3) which is linked in a circuit arrangement (1) on the input side with signal connections (P1, P2, . . . Pn) which can be configured as inputs and outputs, in which the following procedural steps are performed:
a test is made as to whether at least one of the signal connections (P1, P2, . . . Pn) is overmodulated by an impermissible input voltage value,
each signal connection identified as an overmodulated signal connection (P1, P2, . . . Pn) is configured as an output and set to a defined logical signal level.

2. Procedure according to claim 1, wherein the following procedural steps are performed to test whether a signal connection (P1, P2, . . . Pn) is overmodulated:
the signal connection (P1, P2, . . . Pn) is configured as an input,
the input voltage value at the signal connection (P1, P2, . . . Pn) is converted by an analog-digital converter (2) connected on the load side of the multiplexer (3) into a digital data value (s) which lies within a data range limited by a lower data limit value and an upper data limit value,
if the digital data value equals the upper or lower data limit value, the signal connection (P1, P2, . . . Pn) is identified as overmodulated.

3. Procedure according to claim 2, wherein the procedural steps are repeated cyclically and wherein a signal connection (P1, P2, . . . Pn) which has been identified as an overmodulated signal connection in a previous cycle and has been configured as an output is released for configuration as an input if it is no longer overmodulated.

4. Procedure according to claim 3, wherein each overmodulated signal connection (P1, P2, . . . Pn) configured as an output is set to a high level as a defined logical signal level if the input voltage value at this signal connection (P1, P2, . . . Pn) is converted by the analog-digital converter (2) into a data value equal to the upper data limit value.

5. Procedure according to claim 3, wherein each overmodulated signal connection (P1, P2, . . . Pn) configured as an output is set to a low level as a defined logical signal level if the input voltage value at this signal connection (P1, P2, . . . Pn) is converted by the analog-digital converter (2) into a data value equal to the lower data limit value.

6. Procedure according to claim 3, wherein each overmodulated signal connection (P1, P2, . . . Pn) configured as an output is set to a high level as a defined logical signal level if the input voltage value at this signal connection (P1, P2, . . . Pn) is converted by the analog-digital converter (2) into a data value equal to the upper data limit value, and is set to a low level as a defined logical signal level if the input voltage value at this signal connection (P1, P2, . . . Pn) is converted by the analog-digital converter (2) into a data value equal to the lower data limit value.
